(19) United States
(12) Patent Application Publication
(10) Pub. No.: US 2015/0121168 A1
(43) Pub. Date: Apr. 30, 2015

(54) MEMORY SYSTEM INCLUDING RANDOMIZER AND DE-RANDOMIZER

(71) Applicant: SK hynix Inc., Gyeonggi-do (KR)

(72) Inventor: Tae Hoon KIM, Gyeonggi-do (KR)

(73) Assignee: SK hynix Inc., Gyeonggi-do (KR)

(21) Appl. No.: 14/219,775

(22) Filed: Mar. 19, 2014

(30) Foreign Application Priority Data
Oct. 29, 2013 (KR) 10-2013-0129469

(51) Int. Cl. G06F 11/14; G06F 11/16

(52) U.S. Cl. CPC G06F 11/1435; G06F 11/1666
USPC 714/764; 711/162

(57) ABSTRACT

A memory system according to an embodiment of the present invention may include a semiconductor memory device including a plurality of memory areas, and a controller suitable for writing data to the semiconductor memory device and reading data from the semiconductor memory device. The controller provides a combined seed, which is used to copy data in a first memory area to a second memory area, to the semiconductor memory device, the combined seed being obtained by performing an operation on a de-randomizing seed corresponding to the first memory area and a randomizing seed corresponding to the second memory area.

### CROSS-REFERENCE TO RELATED APPLICATION

The present application claims priority to Korean patent application number 10-2013-0129469, filed on Oct. 29, 2013, the entire disclosure of which is hereby incorporated herein in its entirety by reference.

### BACKGROUND

1. Field of Invention

Various exemplary embodiments of the present invention relate generally to an electronic device, and more particularly, to a memory system.

2. Description of Related Art

A semiconductor memory device is a storage device using a semiconductor made from, for example, silicon (Si) germanium (Ge), gallium arsenide (GaAs) or indium phosphide (InP). Semiconductor memory devices may be classified into volatile memory devices and non-volatile memory devices.

Volatile memory devices are unable to retain the stored data when the power is off. Examples of the volatile memory devices may include Static Random Access Memory (SRAM), Dynamic RAM DRAM) and Synchronous DRAM (SDRAM). Non-volatile memory devices can retain the stored data regardless of power on/off conditions. Examples of the non-volatile memory include Read Only Memory (ROM) Mask ROM (MROM), Programmable ROM (PROM), Erasable Programmable ROM (EPROM), Electrically Erasable and Programmable ROM (EEPROM), flash memory, Phase-change RAM (PRAM), Magnetic RAM (MRAM), Resistive RAM (RRAM) and Ferroelectric RAM (FRAM). Flash memories may be classified into NOR-type memories and NAND-type memories.

### SUMMARY

Exemplary embodiments of the present invention are directed to a memory system having improved operating speed and a method of operating the same.

A memory system according to an embodiment of the present invention may include a semiconductor memory device including a plurality of memory areas, and a controller suitable for writing data to the semiconductor memory device and reading data from the semiconductor memory device. The controller provides a combined seed, which is used to copy data in a first memory area to a second memory area, to the semiconductor memory device, the combined seed being obtained by performing an operation on a de-randomizing seed corresponding to the first memory area and a randomizing seed corresponding to the second memory area.

A method according to an embodiment of the present invention, of controlling a semiconductor memory device having a plurality of memory areas, includes combining data which is externally input with a randomizing seed corresponding to a first memory area, controlling the semiconductor memory device to to combined data to the first memory area, performing an operation on a de-randomizing seed corresponding to the first memory area and a randomizing seed corresponding to the second memory area to generate a combined seed that is used to copy the combined data in the first memory area to the second memory area, and providing the combined seed to the semiconductor memory device.

A semiconductor memory device according to another embodiment of the present invention may include a first memory area and a second memory area, a read and write circuit coupled to the first memory area and the and second memory area, and a logic operation block suitable for performing an operation on original data stored in the first memory area, and a combined seed to generate copy data when the original data is read by the read and write circuit. The read and write circuit writes the copy data to the second memory area.

### BRIEF DESCRIPTION OF THE DRAWINGS

FIG. 1 is a block diagram illustrating a memory system including a semiconductor memory device;

FIG. 2 is a flowchart illustrating an operating method of a controller in a write operation;

FIG. 3 is a flowchart illustrating an operating method of a controller in a read operation;

FIG. 4 is a flowchart illustrating an operating method of a controller according to an embodiment of the present invention;

FIG. 5 is a block diagram illustrating a semiconductor memory device according to an embodiment of the present invention;

FIG. 6 is a conceptual diagram illustrating a copy operation in detail;

FIG. 7 is a block diagram illustrating a semiconductor memory device according to another embodiment of the present invention;

FIG. 8 is a block diagram illustrating an application example of the memory system shown in FIG. 1;

FIG. 9 is a view illustrating a method of correcting an error in copy data after a copy operation is completed;

FIG. 10 is a block diagram illustrating an example of an application of the memory system shown in FIG. 9; and

FIG. 11 is a block diagram illustrating the memory system described with reference to FIG. 10.

### DETAILED DESCRIPTION

Hereinafter, various exemplary embodiments of the present invention will be described in detail with reference to the accompanying drawings. The figures are provided to enable those of ordinary skill in the art to make and use the present invention according to the exemplary embodiments of the present invention.

Furthermore, “connected/coupled” represents that one component is directly coupled to another component or indirectly coupled through another component. In this specification, a singular form may include a plural form as long as it is not specifically mentioned in sentence. Furthermore “include/comprise” or “including/comprising” used in the specification represents that one or more components, steps, operations, and elements exists or are added.

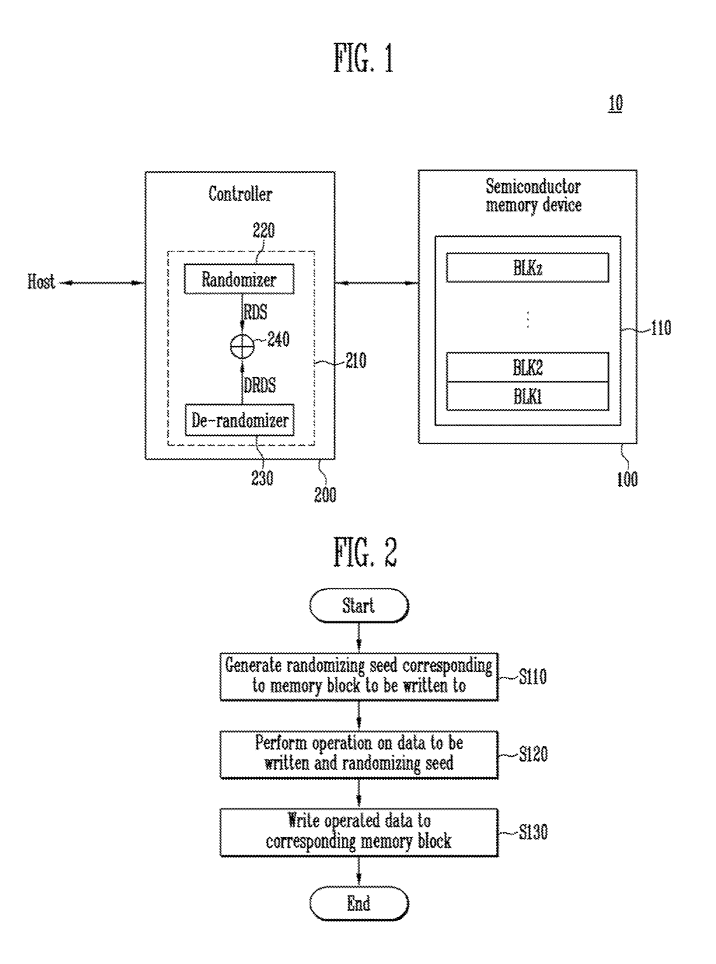

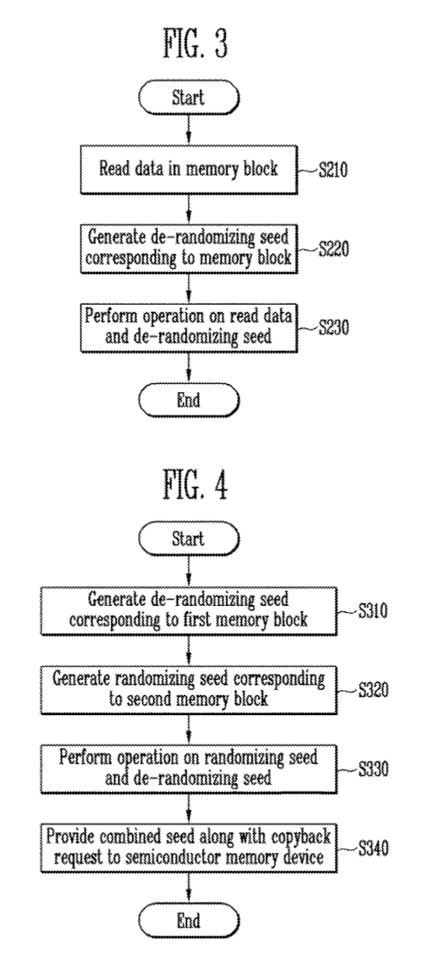

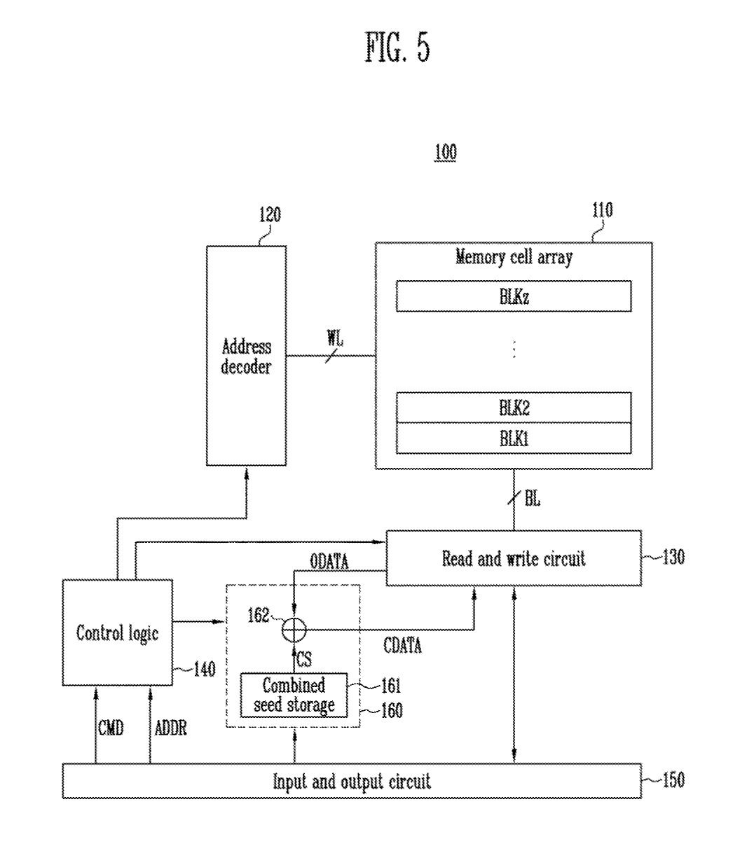

FIG. 1 is a block diagram illustrating a memory system 10 including a semiconductor memory device 100. FIG. 2 is a flowchart illustrating an operating method of a controller 200 during a write operation. FIG. 3 is a flowchart illustrating a method of operating the controller 200 during a read operation.

Referring to FIG. 1, the memory system 10 may include the semiconductor memory device 100 and the controller 200. The semiconductor memory device 100 may include a memory cell array 110.

The memory cell array 110 may include a plurality of memory areas. As illustrated in FIG. 1, the memory areas may be a plurality of memory blocks BLK1 to BLKz. Each of the memory blocks may be a unit of erasure. Each of the memory blocks BLK1 to BLKz may include a plurality of memory cells.

The semiconductor memory device 100 may controlled by the controller 200.

The semiconductor memory device 100 may write data to the memory cell array 110 in response to a write request from the controller 200. When the write request, which may include a write command, an address, and data, are input from the controller 200, the semiconductor memory device 100 may write the data to memory cells indicated by the address.

In response to a read request from the controller 200, the semiconductor memory device 100 may perform a read operation. When the read request having a read command and an address, are input from the controller 200, the semiconductor memory device 100 may read data from memory cells indicated by the address and output the read data to the controller 200.

Additionally, the semiconductor memory device 100 may copy data in any memory area of the memory cell array 110 to another memory area in response to a copy request from the controller 200. For example, the semiconductor memory device 100 may copy data in a first memory block BLK1 to a second memory block BLK2.

According to an embodiment of the present invention, the semiconductor memory device 100 may be a flash memory device. However, it is understood that the technical spirit of the present invention is not limited to the flash memory device.

The controller 200 may be coupled between the semiconductor memory device 100 and a host. The controller 200 may be suitable for interfacing the host and the semiconductor memory device 100. The controller 200 may transmit a write request or a read request to the semiconductor memory device 100 under control of the host. In addition, the controller 200 may control the semiconductor memory device 100 to perform a copy operation.

The controller 200 may include a seed supply unit 210, The seed supply unit 210 may include a randomizer 220, a de-randomizer 230, and a logic operation block 240.

The randomizer 220 and the de-randomizer 230 may provide a randomizing seed RDS and a de-randomizing seed DRDS, respectively, which may correspond to a memory area being accessed for example, a write or read area. According to an embodiment of the present invention, the memory area may refer to a single memory block BLK. Hereinafter, a single memory block BLK may refer to a single memory area for the convenience of illustration.

The randomizer 220 may be activated during a write operation. Referring to FIG. 2, during the write operation at step S110, the randomizer 220 may generate the randomizing seed RDS corresponding to a memory block to be written to. That is, when a block address of the memory block to be written to is provided to the randomizer 220, the randomizer 220 may generate the randomizing seed RDS corresponding to the memory block. That is, the randomizer 220 may be suitable for providing the randomizing seed RDS corresponding to the memory block to be written to, from among randomizing seeds corresponding to the plurality of memory blocks BLK1 to BLKz.

Subsequently, at step S120, the controller 200 may perform an operation on data which is input from the host, and the randomizing seed RDS which is generated from the randomizer 220, and write the operated data to the corresponding memory block of the semiconductor memory device 100 at step S130.

When the data operated on the basis of the randomizing seed RDS is written to the memory cell array 110, threshold voltage distribution of the memory cells in the memory cell array 110 may be improved, and reliability of the data stored in the memory cells may be improved.

The de-randomizer 230 may be activated during a read operation. Referring to FIG. 3 at step S210, the controller 200 may read data from the semiconductor memory device 100 during the read operation. Subsequently, a de-randomizing seed corresponding to the read memory block may be generated at step S220. That is, when a block address of the read memory block is provided to the de-randomizer 230, the de-randomizer 230 may generate the de-randomizing seed DRDS corresponding to the memory block. Additionally, the de-randomizer 230 may be suitable for providing the de-randomizing seed DRDS corresponding to the read memory block, from among de-randomizing seeds corresponding to the plurality of memory blocks BLK1 to BLKz.

Subsequently, the controller 200 may perform an operation on the read data and the de-randomizing seed DRDS at step S230, and the operated data may be transferred to the host.

Referring again to FIG. 1, the memory system 10 may read data from a predetermined memory block of the semiconductor memory device 100 and write the read data to another memory block, hereinafter referred to as copy operation. Hereinafter, for the convenience of illustration, a memory block from which data is read during a copy operation is defined as the first memory block BLK1, and a memory block to which the data is written is defined as the second memory block BLK2.

A randomizing seed and a de-randomizing seed may differ from memory blocks.

According to an embodiment data that is read from the first memory block BLK1 may be transferred to the controller 200 so that the data may be processed into data that is written to the second memory block BLK2. The controller 200 may perform an operation on the read data and the de-randomizing seed DRDS provided from the de-randomizer 230, and re-perform an operation on the operated data and the randomizing seed RDS provided from the randomizer 220. The controller 200 may transfer the re-operated data to the semiconductor memory device 100 so that the data may be written to the second memory block BLK2.

For example, the data to be written to the second memory block BLK2 may be operated according to the following equation,

CDATA=(ODATA [symbol] DRDS) [symbol] RDS. [Equation 1]

Referring to Equation 1, ODATA may denote data read from the first memory block BLK1, hereinafter referred to as “original data ODATA”, and CDATA may denote data to be written to the second memory block BLK2, hereinafter referred to as “copy data CDATA”. The controller 200 may perform an operation on the original data ODATA and the de-randomizing seed DRDS, and re-perform an operation on the operated data and the randomizing seed RDS to generate the copy data CDATA. For example, the above-described operations may be XOR operations.

According to the above-described method, after the original data ODATA is transferred to the controller 200 from the semiconductor memory device 100, the controller 200 may process the original data ODATA into the copy data CDATA according to Equation 1 and transfer the copy data CDATA to the semiconductor memory device 100. As a result, it may take time to exchange the original data ODATA and the copy data CDATA between the semiconductor memory device 100 and the controller 200.

According to another embodiment of the present invention, during a copy operation the controller 200 may provide a combined seed, obtained by performing an operation on the de-randomizing seed corresponding to the first memory block BLK1 and the randomizing seed corresponding to the second memory block BLK2, to the semiconductor memory device 100.

Therefore, the semiconductor memory device 100 may generate copy data by performing an operation on the original data ODATA and the combined seed.

For example, the copy data may be operated according to the following equations,

CS=DRD [symbol] RDS and [Equation 2]

CDATA=ODATA [symbol] CS. [Equation 3]

According to Equations 2 and 3, CS may denote a combined seed, ODATA may denote original data, and CDATA may denote copy data. In Equations 2 and 3, unlike Equation 1, the combined seed CS may be obtained by performing an operation on the de-randomizing seed DRDS and the randomizing seed RDS first, and then an operation may be performed on the combined seed CS and the original data ODATA.

As a result, to generate the copy data CDATA, the semiconductor memory device 100 may read the original data ODATA from the first memory block BLK1, and perform an operation on the original data ODATA and the combined seed CS provided from the controller 200.

According to an embodiment of the present invention, during a copy operation, time may not be required to exchange original data and copy data between the semiconductor memory device 100 and the controller 200. Therefore, speed of the copy operation may be increased.

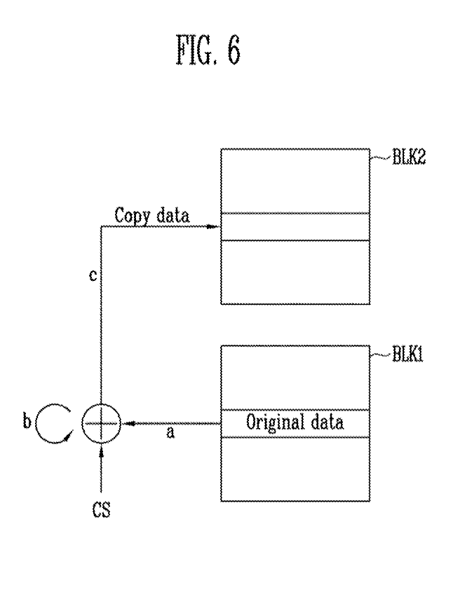

FIG. 4 is a flowchart illustrating a method of operating the controller 200 according to an embodiment of the present invention.

Referring to FIGS. 1 and 4, the controller 200 may generate the de-randomizing seed DRDS corresponding to the first memory block BLK1 at step S310. The controller 200 may generate the randomizing seed RDS corresponding to the second memory block BLK2 at S320.

The controller 200 may perform an operation on the de-randomizing seed DRDS and the randomizing seed RDS to generate a combined seed at step S330. For example, an XOR operation may be performed.

The controller 200 may transfer the combined seed along with a copy request to the semiconductor memory device 100 at step S340. The copy request may include a copy command, an address of the first memory block BLK1, and an address of the second memory block BLK2. The semiconductor memory device 100 may internally perform a copy operation in response to the copy command.

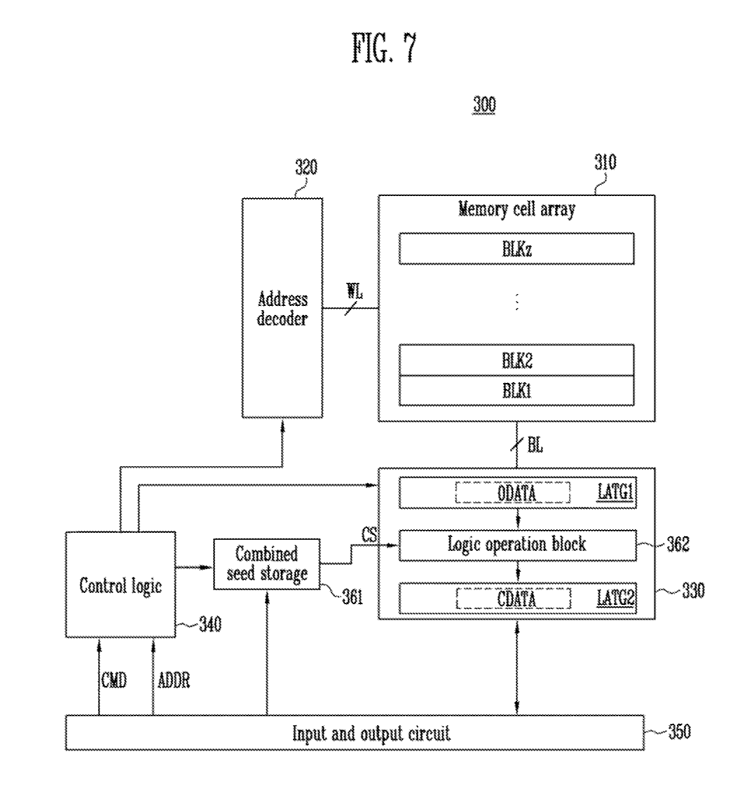

FIG. 5 is a block diagram illustrating the semiconductor memory device 100 according to an embodiment of the present invention.

Referring to FIG. 5, the semiconductor memory device 100 may include the memory cell array 110, an address decoder 120, a read and write circuit 130, a control logic 140, an input/output circuit 150, and a data processor 160.

As illustrated in FIG. 1 the memory cell array 110 may include the plurality of memory blocks BLK1 to BLKz. The plurality of memory blocks BLK1 to BLKz may be coupled to the address decoder 120 through word lines WL, and to the read and to circuit 130 through bit lines BL. Each of the plurality of memory blocks BLK1 to BLKz may include a plurality of memory cells. Each of the memory cells may be defined as a single level cell or a multi level cell storing at least two data bits. According to an embodiment of the present invention, the memory cells may be non-volatile memory cells.

The address decoder 120, the read and write circuit 130, the control logic 140 and the input/output circuit 150 may operate as a peripheral circuit.

The address decoder 120 may be coupled to the memory cell array 110 through the word lines WL. The address decoder 120 may be controlled by the control logic 140. The address decoder 120 may receive addresses ADDR through the control logic 140.

The address decoder 120 may be suitable for decoding a block address, among the addresses ADDR. The address decoder 120 may select one of the memory blocks BLK1 to BLKz in response to the decoded block address.

The address decoder 120 may decode a row address, from among the addresses ADDR. The address decoder 120 may be suitable for selecting a single word line of the selected memory block in response to the decoded row address.

According to an embodiment, the address decoder 120 may include an address buffer, a block decoder and an address decoder.

The read and write circuit 130 may be coupled to the memory cell array 110 through the bit lines BL. The read and write circuit 130 may be controlled by the control logic 140.

During a write operation, the read and write circuit 130 may write data, which is input through the input/output circuit 150, to memory cells of the selected word line. The read and write circuit 130 may read data from the memory cells of the selected word line and output the data to the input/output circuit 150.

During a copy operation, the read and write circuit 130 may read original data from memory cells from a selected word line of the first memory block BLK1 and provide the read data to the data processor 160. Additionally, the read and write circuit 130 may receive the copy data CDATA from the data processor 160 and write the copy data CDATA to memory cells of a selected word line of the second memory block BLK2.

According to an embodiment of the present invention, the read and write circuit 130 may include page buffers.

The control logic 140 may receive a command CMD and the addresses ADDR from the input/output circuit 150. The control logic 140 may transfer the addresses ADDR to the address decoder 120. Additionally, in response to the command CMD, the control logic 140 may control the address decoder 120, the read and write circuit 130, the input/output circuit 150 and the data processor 160.

The input/output circuit 150 may be coupled to the read and write circuit 130 and the control logic 140. The input/output circuit 150 may be controlled by the control logic 140. The input/output circuit 150 may receive the command CMD and the addresses ADDR from the controller 200, and transfer the command CMD and the addresses ADDR to the control logic 140.

According to an embodiment of the present invention, the semiconductor memory device 100 may include the data processor 160. The data processor 160 may be controlled by the control logic 140.

The data processor 160 may include a logic operation block 162 and a combined seed storage 161. The combined seed storage 161 may temporarily store the combined seed CS, which is provided from the controller 200 through the input/output circuit 150. The combined seed CS stored in the combined seed storage 161 may be provided to the logic operation block 162.

The logic operation block 162 may perform an operation on the original data ODATA and the combined seed CS in response to control of the control logic 140. For example, the logic operation block 162 may perform an XOR operation. The copy data CDATA may be generated as a result of the operation. The copy data CDATA may be provided to the read and write circuit 130.

According to an embodiment of the present invention, the semiconductor memory device 100 may internally generate the copy data CDATA on the basis of the combined seed CS. During a copy operation, original data and copy data may not be transmitted and received between the semiconductor memory device 100 and the controller 200. As a result, speed of the copy operation may be increased.

FIG. 6 is a detailed conceptual view illustrating a copy operation.

Referring to FIG. 6, a copy operation may be performed in such a manner that original data may be written from the memory cells of the selected word line of the first memory block BLK1 (a). To generate copy data, an operation may be performed on the original data and the combined seed CS (b), and the copy data may be written to the memory cells of the selected word line of the second memory block BLK2.

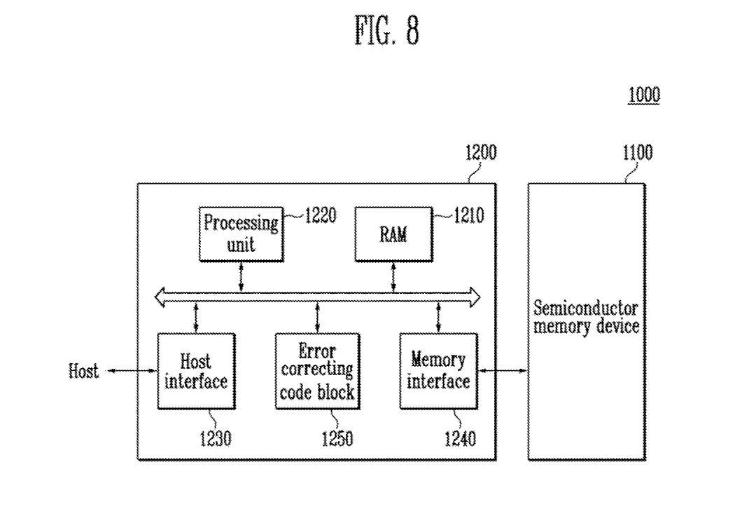

FIG. 7 is a block diagram illustrating the semiconductor memory device 300 according to another embodiment of the present invention.

Referring to FIG. 7, a semiconductor memory device 300 may include a memory cell array 310, an address decoder 320, a read and write circuit 330, a control logic 340, an input/output circuit 350, and a combined seed storage 361.

The memory cell array 310, the address decoder 320, control logic 340, and the input/output circuit 350 may be configured in substantially the same manner as the memory cell array 110, the address decoder 120, the control logic 140, and the input/output circuit 150 are configured, as described above with reference to 5. Hereinafter, a description of earlier described embodiments is omitted.

The read and write circuit 330 may include a first latch group LATG1, a second latch group LATG2 and a logic operation block 362. According to an embodiment of the present invention, a single latch in the first latch group LATG1 and a single latch in the second latch group LATG2 of each bit line may form a single page buffer, and this page buffer may be coupled to the corresponding bit line.

According to an embodiment of the present invention, the logic operation block 362 may be provided in the read and write circuit 330. The logic operation block 362 may be composed of transistors in the read and write circuit 330. The logic operation block 362 may be coupled between the first latch group LATG1 and the second latch group LATG2 of the read and write circuit 330.

During the copy operation, the read and write circuit 130 may read the original data ODATA from the memory cells of the selected word line of the first memory block BLK1 in response to control of the control logic 340. The read data ray be stored in the first latch group LATG1.

The logic operation block 362 may perform an operation on the combined seed CS from the combined seed storage 361 and the original data ODATA from the first latch group LATG1 to generate the copy data CDATA in response to control of the control logic 340. The generated copy data CDATA may be stored in the second latch group LATG2.

Thereafter, the copy data CDATA may be written to the second memory block BLK2.

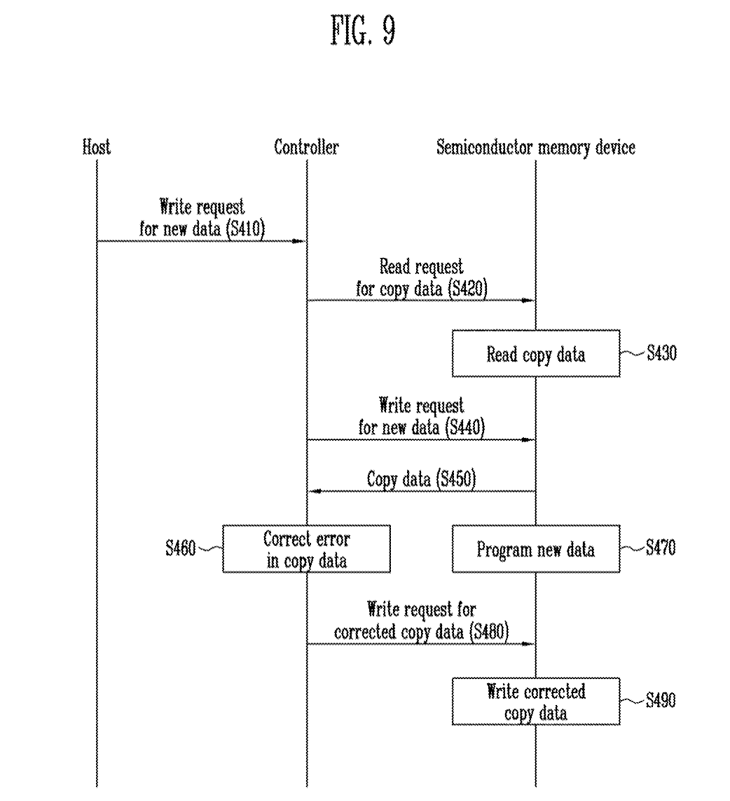

FIG. 8 is a block diagram illustrating an example of an application 1000 of the memory system 10 shown in FIG. 1.

Referring to FIG. 8, a memory system 1000 may include a semiconductor memory device 1100 and a controller 1200.

The semiconductor memory device 1100 may be configured in substantially the same manner as the semiconductor memory device 100 described above with reference to FIG. 5 or the semiconductor memory device 300 above described with reference to FIG. 7. Hereinafter, a description of earlier described embodiments is omitted.

The controller 1200 may be coupled to the semiconductor memory device 1100 and the host. The controller 1200 may include a random access memory (RAM) 1210, a processing unit 1220, a host interface 1230, a memory interface 1240, and an error correcting code (ECC) block 1250.

The RAM 1210 may function as at least one of an operation memory of the processing unit 1220, a cache memory between the semiconductor memory device 1100 and the host, and a buffer memory between the semiconductor memory device 1100 and the host. The processing unit 1220 may control the general operation of the controller 1200.

According to an embodiment of the present invention, the processing unit 1220 may drive firmware to perform functions of the randomizer 220, the de-randomizer 230 and the logic operation block 240 described above with reference to FIG. 1. According to another embodiment, the semiconductor memory device 100 may store source codes for the functions of the randomizer 220, the de-randomizer 230, and the logic operation block 240, these source codes may be loaded into the RAM 1210 when the memory system 1000 is driven, and by using the source codes loaded into the RAM 1210, the processing unit 1220 may perform the functions of the randomizer 220, the de-randomizer 230 and the logic operation block 240, described above with reference to FIG. 1. Additionally, the controller 1200 having various other configurations may also perform the functions of the randomizer 220, the de-randomizer 230, and the logic operation block 240. For example, the controller 1200 may include hardware configurations corresponding to the randomizer 220, the de-randomizer 230, and the logic operation block 240.

The host interface 1230 may include a protocol for data exchange between the host and the controller 1200. According to an exemplary embodiment of the present invention, the controller 1200 may communicate with the host through one of various interface protocols including a Universal Serial Bus (USB) protocol, a multimedia card (MMC) protocol, a peripheral component interconnection (PCI) protocol, a PCI-express (PCI-E) protocol, an Advanced Technology Attachment (ATA) protocol, a Serial-ATA protocol, a Parallel-ATA protocol, a small computer small interface (SCSI) protocol, an enhanced small disk interface (ESDI) protocol, an Integrated Drive Electronics (IDE) protocol and a private protocol.

The memory interface 1240 may interface with the semiconductor memory device 1100. For example, the memory interface may include a NAND interface or a NOR interface.

The ECC block 1250 may detect and correct an error in data read from the semiconductor memory device 1100 by using an error correcting code (ECC). In a copy operation according to an embodiment of the present invention, since the controller 1200 does not receive the original data ODATA shown in FIG. 5, an error in the copy data CDATA, which is written during the copy operation, may not be corrected. According to an embodiment of the present invention, the error in the copy data CDATA may be corrected after the copy operation is completed. This will be described in detail below with reference to FIG. 9.

The controller 1200 and the semiconductor memory device 1100 may be integrated into a single semiconductor device. In an exemplary embodiment, the controller 1200 and the semiconductor memory device 1100 may be integrated into a single semiconductor device to form a memory card such as a PC card (personal computer memory card international association (PCMCIA)), a compact flash (CF) card, a smart media card (SM or SMC), a memory stick, a multimedia card (MMC, RS-MMC or MMCmicro), an SD card (SD, miniSD, microSD or SDHC), or universal flash storage (UFS).

The controller 1200 and the semiconductor memory device 1100 may be integrated into a single semiconductor device to form a semiconductor drive (Solid State Drive (SSD)). The semiconductor drive (SSD) may include a storage device that stores data in a semiconductor memory. When the memory system 1000 is used as the semiconductor drive (SSD), an operating speed of the host coupled to the memory system 1000 may be significantly improved.

In another example, the memory system 1000 may be used as one of various components of an electronic device, such as a computer, an ultra mobile PC (UMPC), a workstation, a netbook, a personal digital assistant (PDA), a portable computer, a web tablet, a wireless phone, a mobile phone, a smart phone, an e-book, a portable multimedia player (PMP), a portable game machine, a navigation device, a black box, a digital camera, a three-dimensional (3D) television, a digital audio recorder, a digital audio player, a digital picture recorder, a digital picture player, a digital video recorder, a digital video player, a device for transmitting/receiving information in wireless environment, one of various electronic devices for home network, one of various electronic devices for computer network, or one of various electronic devices for telematics network, an RFID device and/or one of various devices for computing systems, etc.

In an exemplary embodiment of the present invention, the semiconductor memory device 1100 or the memory system 1000 may be packaged in a variety of ways. For example, in some embodiments, the semiconductor memory device 1100 or the memory system 1000 may be packaged using various methods such as a package on package (PoP), ball grid arrays (BGAs), chip scale packages (CSPs), a plastic leaded chip carrier (PLCC), a plastic dual in line package (PDIP), a die in waffle pack, a die in wafer form, a chip on board (COB), a ceramic dual in line package (CERDIP), a plastic metric quad flatpack (MQFP), a thin quad flatpack (TQFP), a small outline integrated circuit (SOIC), a shrink small outline package (SSOP), a thin small outline package (TSOP), a thin quad flatpack (TQFP), a system in package (SIP), a multi chip package (MCP), a wafer-level fabricated package (WFP) and/or a wafer-level processed stack package (WSP), etc.

FIG. 9 is a view illustrating a method of correcting an error in the copy data CDATA after a copy operation is completed.

Referring to FIGS. 8 and 9, the host may instruct the controller 1200 to write new data at step S410. When a write request for the new data is input, the controller 1200 may transfer a read request for the copy data CDATA, shown in FIG. 5, to the semiconductor memory device 1100 at step S420.

The semiconductor memory device 1100 may read the copy data CDATA at step S430. The controller 1200 may transfer the write request for the new data to the semiconductor memory device 1100 at step S440. For example, step S440 may be performed while a read operation is being performed on the copy data CDATA at step S430.

When the read operation on the copy data CDATA is completed, the semiconductor memory device 1100 may transfer the copy data CDATA to the controller 1200 at step S450.

The controller 1200 may correct an error in the copy data CDATA by using the ECC block 1250 at step S460. The semiconductor memory device 1100 may perform a program operation on the new data at step S470. Step S460 and step S470 may be performed in parallel. That is, error correction of the copy data CDATA may be performed in parallel with the program operation that takes more time to perform.

The controller 1200 may transfer the write request for the corrected copy data to the semiconductor memory device 1100 at step S480. For example, step S480 may be performed while the program operation is being performed on the new data at step S470.

The semiconductor memory device 1100 may store the corrected copy data in the corresponding memory block at step S490.

According to an embodiment of the present invention, error correction of the copy data CDATA may be performed in parallel with a program operation that takes more time to perform. Therefore, a speed reduction of the memory system 1000 due to the error correction of the copy data CDATA may be prevented.

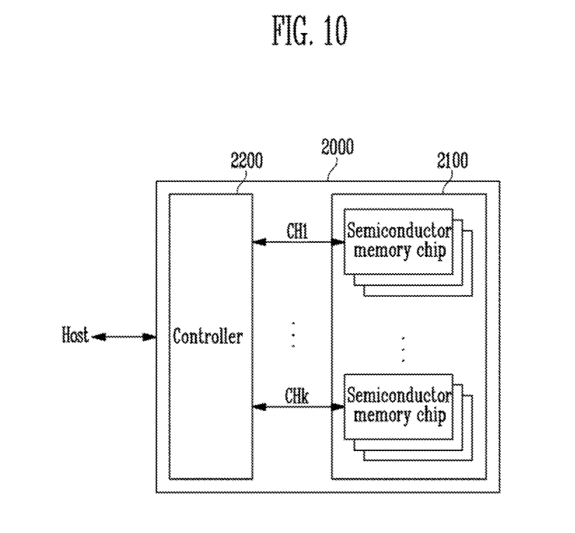

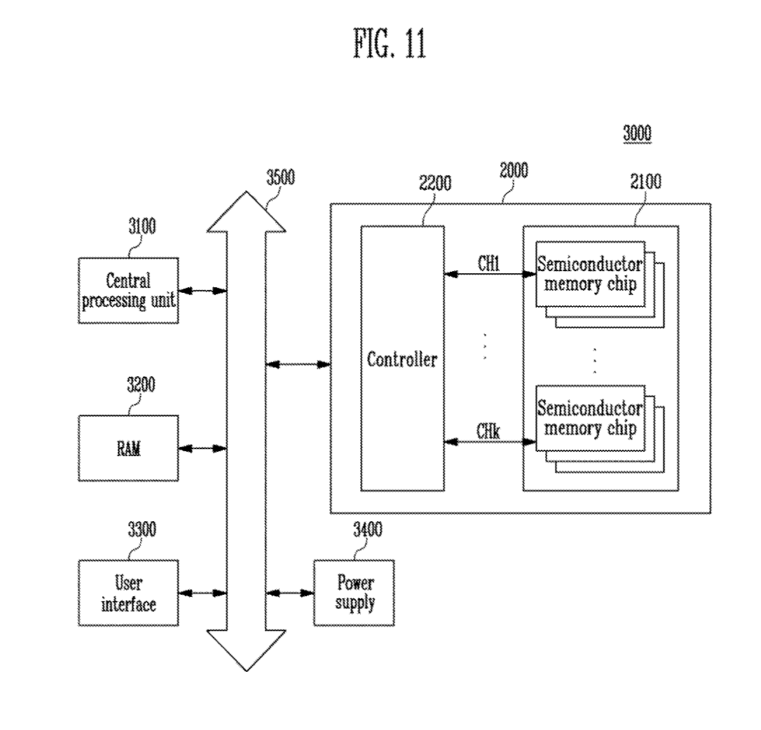

FIG. 10 is a block diagram illustrating an example of an application 2000 of the memory system 1000 shown in FIG. 9.

Referring to FIG. 10, a memory system 2000 may include a semiconductor memory device 2100 and a controller 2200. The semiconductor memory device 2100 may include a plurality of semiconductor memory chips. The plurality of semiconductor memory chips may be divided into a plurality of groups.

As illustrated in FIG. 10, the plurality of groups may communicate with the controller 2200 through first to k-th channels CH1 to CHk. Each of the semiconductor chips may be configured and operated in substantially the same manner as the semiconductor memory device 100 described above with reference to FIG. 5 or the semiconductor memory device 300 described above with reference to FIG. 7.

Each of the groups may communicate with the controller 2200 through a single common channel. The controller 2200 may have substantially the same configuration as the controller 1200 described above with reference to FIG. 7 and may control the plurality of memory chips of the semiconductor memory device 2100 through the first to k-th channels CH1 to CHk.

As illustrated in FIG. 10, the plurality semiconductor memory chips may be coupled to a single channel. However, the memory system 2000 may be modified so that a single memory chip may be coupled to a single channel.

FIG. 11 is a block diagram illustrating a computing system 3000 that includes the memory system 2000 described above with reference to FIG. 10.

Referring to FIG. 11, the computing system 3000 may include a central processing unit (CPU) 3100, a random access memory (RAM) 3200, a user interface 3300, a power supply 3400, a system bus 3500, and the memory system 2000.

The memory system 2000 may be electrically connected to the CPU 3100, the RAM 3200, the user interface 3300 and the power supply 3400 through the system bus 3500. The memory system 2000 may store data that is provided through the user interface 3300 or processed by the CPU 3100.

As illustrated in FIG. 11, the semiconductor memory device 2100 may be coupled to the system bus 3500 through the controller 2200. However, the semiconductor memory device 2100 may be directly coupled to the system bus 3500. Functions of the controller 2200 may be performed by the CPU 3100 and the RAM 3200.

As illustrated in FIG. 11, the memory system 2000, described above with reference to FIG. 10, may be provided, or the memory system 2000 may be replaced by the memory system 10 described above with reference to FIG. 1 or the memory system 1000 described above with reference to FIG. 9. According to another embodiment of the present invention, the computing system 3000 may include the memory systems 10, 1000 and 2000 described above with reference to FIGS. 1, 9 and 10, respectively.

According to an embodiment of the present invention, time may not be required to transmit and receive original data and copy data between a semiconductor memory device and a controller during a copy operation. Therefore, speed of the copy operation may be increased.

According to embodiments of the present invention, a memory system having improved operating speed and a method of operating the same are provided.

As described above, the exemplary embodiments have been disclosed in the drawings and the specification. The specific terms used herein are for purposes of illustration, and do not limit the scope of the present invention defined in the claims. Accordingly, those skilled in the art will appreciate that various modifications and another equivalent example may be made without departing from the scope and spirit of the present disclosure. Therefore, the technical protection scope of the present invention will be defined by the technical spirit of the accompanying claims.

What is claimed is:

1. A memory system, comprising:
a semiconductor memory device including a plurality of memory areas; and
a controller suitable for writing data to the semiconductor memory device and reading data from the semiconductor memory device,
wherein the controller provides a combined seed, which is used to copy data in a first memory area to a second memory area, to the semiconductor memory device, the combined seed being obtained by performing an operation on a de-randomizing seed corresponding to the first memory area and a randomizing seed corresponding to the second memory area.

2. The memory system of claim 1, wherein each of the plurality of memory areas corresponds to a different randomizing seed.

3. The memory system of claim 1, wherein the semiconductor memory device includes a logic operation block suitable for performing an operation on the data in the first memory area and the combined seed to generate copy data.

4. The memory system of claim 3, wherein the semiconductor memory device is suitable for writing the copy data to the second memory area.

5. The memory system of claim 4, wherein the controller is suitable for reading the copy data from the semiconductor memory device before a write operation is performed on new data in the semiconductor memory device.

6. The memory system of claim 5, wherein the controller corrects an error in the copy data when the write operation is performed on the new data in the semiconductor memory device.

7. The memory system of claim 6, wherein the copy data in which the error is corrected is re-written to the second memory area.

8. The memory system of claim 1, wherein each of the plurality of memory areas is a memory block as a unit of erasure.

9. A method of controlling a semiconductor memory device including a plurality of memory areas, the method comprising:
combining data, which is externally input, with a randomizing seed corresponding to a first memory area;
controlling the semiconductor memory device to write the combined data to the first memory area;
performing an operation on a de-randomizing seed corresponding to the first memory area and a randomizing seed corresponding to the second memory area to generate a combined seed that is used to copy the combined data in the first memory area to the second memory area; and
providing the combined seed to the semiconductor memory device.

10. The method of claim 9, wherein the semiconductor memory device generates copy data by performing an operation on the combined data in the first memory area and the combined seed.

11. The method of claim 10, wherein the semiconductor memory device writes the copy data to the second memory area.

12. The method of claim 11, further comprising controlling the semiconductor memory device to read the copy data written to the second memory area.

13. The method of claim 12, further comprising correcting an error in the copy data when a write operation is performed on new data in the semiconductor memory device.

14. The method of claim 13, further comprising controlling the semiconductor memory device to write the copy data in which the error is corrected, to the second memory area.

15. The method of claim 9, wherein each of the memory areas is a memory block as a unit of erasure.

16. A semiconductor memory device, comprising:
a first memory area and a second memory area;
a read and write circuit coupled to the first memory area and the second memory area; and
a logic operation block suitable for performing an operation on original data, stored in the first memory area, and a combined seed which is received from the external to generate copy data when the original data is read by the read and write circuit, wherein the read and write circuit writes the copy data to the second memory area.

17. The semiconductor memory device of claim 16, further including a combined seed storage temporarily storing the combined seed, wherein the combined seed is externally input.

18. The semiconductor memory device of claim 16, wherein each of the first and second memory areas corresponds to a different randomizing seed, and the combined seed is determined by performing an operation on a de-randomizing seed corresponding to the first memory area and a randomizing seed corresponding to the second memory area.
